(19) United States
(12) Patent Application Publication
(10) Pub. No.: US 2012/0079459 A1
(43) Pub. Date: Mar. 29, 2012

(54) TRACING MULTIPLE THREADS VIA BREAKPOINTS

(75) Inventors: Cary L. Bates, Rochester, MN (US); David L. Hermsmeier, Oronoco, MN (US)

(73) Assignee: INTERNATIONAL BUSINESS MACHINES CORPORATION, Armonk, NY (US)

(21) Appl. No.: 12/893,195

(22) Filed: Sep. 29, 2010

(51) Int. Cl. G06F 9/44

(52) U.S. Cl. 717/129

(57) ABSTRACT

In an embodiment, a plurality of halted addresses of halted instructions are determined, at which execution of a plurality of threads of a program are halted. A respective next sequential instruction is computed, which is in the plurality of threads following the plurality of halted instructions. A respective next sequential breakpoint at the respective next sequential instruction in the plurality of threads is set. Execution of the plurality of threads is started after the setting the respective next sequential breakpoint. In response to the execution of each of the plurality of threads encountering the respective next sequential breakpoint and all of the plurality of threads halting, trace data is saved that describes the execution of each of the plurality of threads.

### FIELD

An embodiment of the invention generally relates to computer systems and more particularly to tracing multiple threads of a program in a computer system using breakpoints.

### BACKGROUND

Computer systems typically comprise a combination of computer programs and hardware, such as semiconductors, transistors, chips, circuit boards, storage devices, and processors. The computer programs are stored in the storage devices and are executed by the processors. As the sophistication and complexity of computer programs increase, the programs become more difficult to debug. Bugs are problems, faults, or errors in a computer program. Locating, analyzing, and correcting suspected faults in a computer program is a process known as “debugging.” Typically, a programmer uses another computer program commonly known as a “debugger” to debug the program under development.

Conventional debuggers typically support three primary types of operations, which a computer programmer may request via a user interface. A first type is a breakpoint or address watch operation, which permits a programmer to identify with a breakpoint a precise instruction at which to halt execution of the program by the processor, or identify via an address watch, a memory location for the processor to monitor for content modification, at which time the program's execution is halted. As a result, when a program is executed by the debugger, the program executes on the processor in a normal fashion until the breakpoint is reached or the contents of the monitored memory location are written to, at which time the debugger halts execution of the program. A second type is a step operation, which permits a computer programmer to cause the processor to execute instructions in a program either one-by-one or in groups. After each instruction or group of instructions are executed, the debugger then halts execution of the program. Once the execution of the program is halted, either by step or breakpoint operations, conventional debuggers provide a third type of operation, which displays the content that is stored at various storage locations, in response to requests by the programmer. By this debugging process of halting the program at various instructions and examining the content of various storage locations, the programmer might eventually find the storage location whose stored content, such as an instruction or data, is incorrect or unexpected.

### SUMMARY

A method, computer-readable storage medium, and computer system are provided. In an embodiment, a plurality of halted addresses of halted instructions are determined, at which execution of a plurality of threads of a program are halted. A respective next sequential instruction is computed, which is in the plurality of threads following the plurality of halted instructions. A respective next sequential breakpoint at the respective next sequential instruction in the plurality of threads is set. Execution of the plurality of threads is started after the setting the respective next sequential breakpoint. In response to the execution of each of the plurality of threads encountering the respective next sequential breakpoint and all of the plurality of threads halting, trace data is saved that describes the execution of each of the plurality of threads.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example data structure for a breakpoint management table, according to an embodiment of the invention.

FIG. 3 depicts a block diagram of an example data structure for an instruction step breakpoint table, according to an embodiment of the invention.

FIG. 4 depicts a block diagram of an example data structure for a line step breakpoint table, according to an embodiment of the invention.

FIG. 5 depicts a flowchart of example processing for a start instruction trace command, according to an embodiment of the invention.

FIG. 6 depicts a flowchart of example processing for execution of a thread encountering a breakpoint while instruction trace is active, according to an embodiment of the invention.

FIG. 7 depicts a flowchart of example processing for a stop trace command, according to an embodiment of the invention.

FIG. 8 depicts a flowchart of example processing for a start line trace execution command, according to an embodiment of the invention.

FIG. 9 depicts a flowchart of example processing for execution of a thread encountering a breakpoint while line trace is active, according to an embodiment of the invention.

It is to be noted, however, that the appended drawings illustrate only example embodiments of the invention, and are therefore not considered a limitation of the scope of other embodiments of the invention.

### DETAILED DESCRIPTION

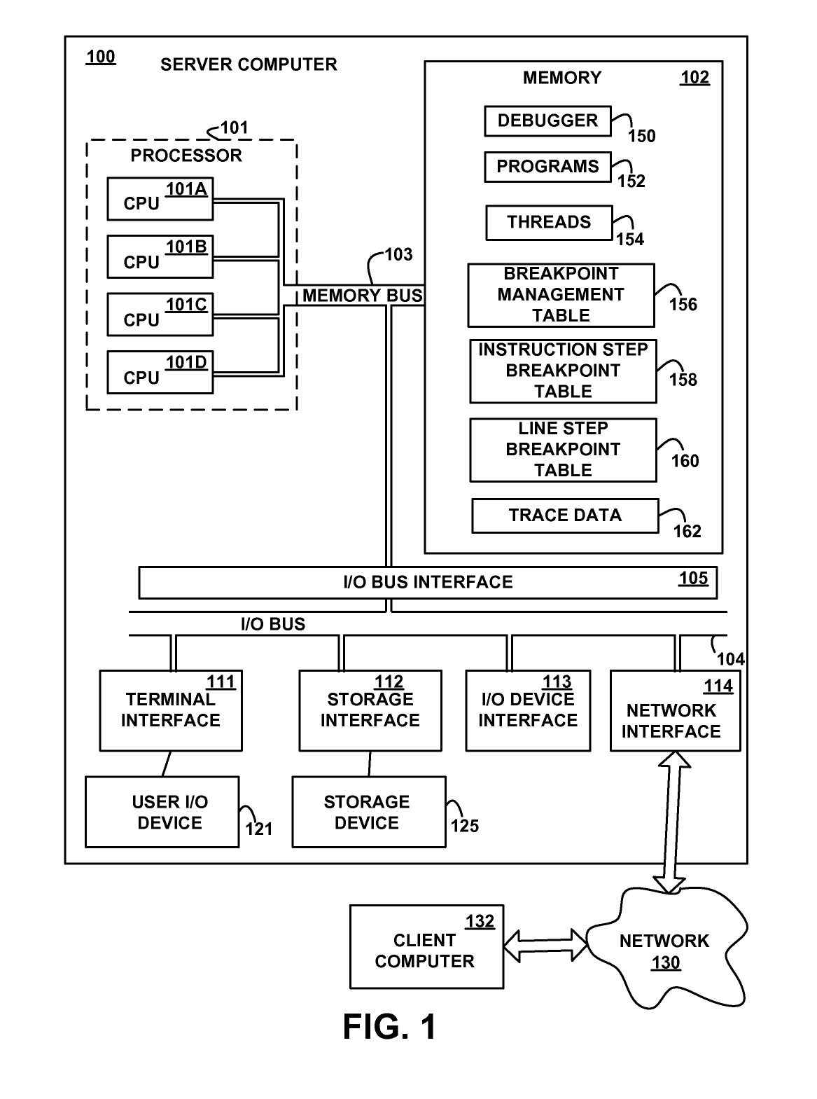

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The term “server” is used herein for convenience only, and in various embodiments a computer system that operates as a client computer in one environment may operate as a server computer in another environment, and vice versa. The mechanisms and apparatus of embodiments of the present invention apply equally to any appropriate computing system.

The major components of the computer system 100 comprise one or more processors 101, a main memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may comprise one or more levels of on-board cache.

In an embodiment, the main memory 102 may comprise a random-access semiconductor memory, storage device, or storage medium for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 is encoded with or stores a debugger 150, programs 152, threads 154, a breakpoint management table 156, an instruction step breakpoint table 158, a line step breakpoint table 160, and trace data 162. Although the debugger 150, the programs 152, the threads 154, the breakpoint management table 156, the instruction step breakpoint table 158, the line step breakpoint table 160, and the trace data 162 are illustrated as being contained within the memory 102, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, the debugger 150, the programs 152, the threads 154, the breakpoint management table 156, the instruction step breakpoint table 158, the line step breakpoint table 160, and the trace data 162 are not necessarily all completely contained in the same storage device at the same time. Further, although the debugger 150, the programs 152, the threads 154, the breakpoint management table 156, the instruction step breakpoint table 158, the line step breakpoint table 160, and the trace data 162 are illustrated as being separate entities, in other embodiments some of them, portions of some of them, or all of them may be packaged together.

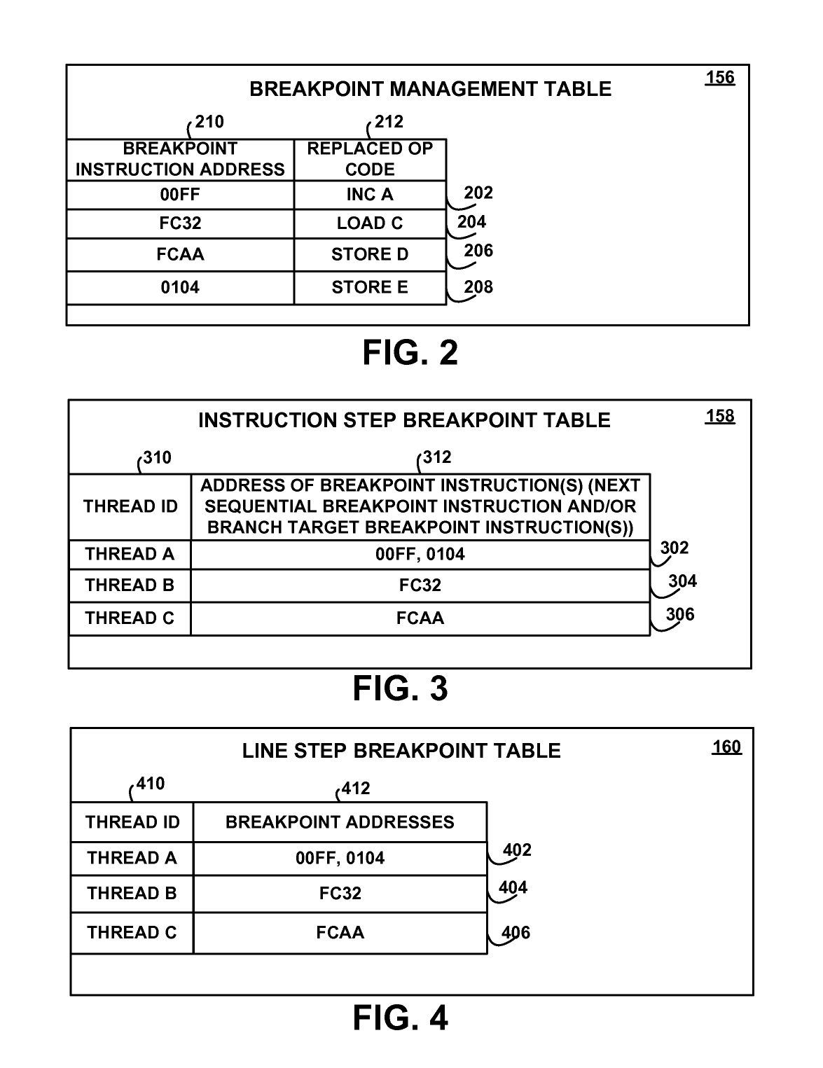

In an embodiment, the debugger 150, the programs 152, and the threads 154 comprise instructions or statements that execute on the processor 101 or instructions or statements that are interpreted by instructions or statements that execute on the processor 101, to carry out the functions as further described below with reference to FIGS. 2, 3, 4, 5, 6, 7, 8, and 9. In another embodiment, the debugger 150, the programs 152, and the threads 154 are implemented in hardware via semiconductor devices, chips, logical gates, circuits, circuit cards, and/or other physical hardware devices in lieu of, or in addition to, a processor-based system. In an embodiment, the debugger 150, the programs 152, and the threads 154 comprise data in addition to instructions or statements.

The program 152 is debugged via the debugger 150. The program 152 may be any type of executable or interpretable code or statements, whether in source or object form. In various embodiments, the program 152 may be an application program, an operating system program, a network application program, an application server program, a server program, a grid program, a scientific calculation manager, a query optimizer, or any other type of program.

In various embodiment, the threads 154, which may also be known as processes or tasks, comprise instances of the same program, executing concurrently, simultaneously, or substantially simultaneously on the same or different processors via parallel computing, multi-tasking, or multiprocessing techniques. In an embodiment, the threads 154 share resources, such as memory and/or a processor, but in other embodiment the threads 154 do not share resources. On a single processor, multithreading occurs by time-division multiplexing, as the single processor switches between different threads 154. This context switching occurs frequently enough that the user perceives the threads 154 as executing simultaneously. On a multiprocessor or multi-core computer system, the threads 154 actually execute simultaneously, with each processor or core executing a particular thread 154.

While execution of the threads 154 of the program 152 is halted, the debugger 150 sets breakpoints in the program 152, e.g., by replacing a valid statement or instruction at a breakpoint location in the program 152 with an invalid instruction and by creating a record for the breakpoint in the breakpoint management table 156. After the breakpoints are set, the debugger 150 resumes execution of the threads 154 of the program 152. In response to the execution of a thread 154 of the program 152 eventually encountering the invalid statement or instruction, a system exception or interrupt occurs, which halts execution of all threads 154 of the program 152 and gives control of the processor 101 to the debugger 150. The debugger 150 then performs processing, such as saving data to the trace data 162, removing breakpoints, and setting other breakpoints before resuming execution of the program 152.

The trace data 162 comprises records that describe the execution of the program 152 at various times. The trace data 162 is used for debugging purposes, and the trace data 162 is not a functional requirement of the program. In various embodiments, each record in the trace data 162 comprises a timestamp of the time and/or date at which the record was created; the instruction and/or address of the instruction that was most recently executed or that was the next instruction to execute at the time of the timestamp; and the values of variables or registers and the contents of memory locations that existed at the time of the timestamp.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the main memory 102, or any portion thereof, may be stored to and retrieved from the storage device 125, as needed. The I/O device interface 113 provides an interface to any of various other input/output devices or devices of other types, such as printers or fax machines. The network adapter 114 provides one or more communications paths from the computer system 100 to other digital devices and computer systems 132; such paths may comprise, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and the computer system 132. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

FIG. 1 is intended to depict the representative major components of the computer system 100 and the network 130. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, radio frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments the invention.

FIG. 2 depicts a block diagram of an example data structure for a breakpoint management table 156, according to an embodiment of the invention. The breakpoint management table 156 comprises example records 202, 204, 206, and 208, each comprising an example breakpoint instruction address field 210 and a replaced operation code field 212. The breakpoint management table 156 may also comprise other optional fields, such as a condition that specifies conditions that must be satisfied, in order for the debugger 150 to give control to a user interface, in response to execution of the program 152 encountering a breakpoint at the breakpoint instruction address 210.

The breakpoint instruction address field 210 identifies the memory address in a program 152 where a breakpoint is set. The replaced operation code field 212 comprises the instruction or statement at the breakpoint instruction address 210 in the program 152 where the breakpoint is set, in the same record. The debugger 150 replaced the instruction at the breakpoint instruction address 210 with an invalid instruction while setting the breakpoint. While removing the breakpoint, the debugger 150 replaces the invalid instruction with the replaced operation code 212 at the breakpoint instruction address 210 and deletes the record in the breakpoint management table 156 of the removed breakpoint.

FIG. 3 depicts a block diagram of an example data structure for an instruction step breakpoint table 158, according to an embodiment of the invention. The instruction step breakpoint table 158 comprises example records 302, 304, and 306, each comprising an example thread identifier field 310 and an address field 312. The thread identifier field 310 specifies an identifier of a thread 154 in a program 152. The address field 312 specifies an address of breakpoint instruction(s) that are set in the program 152 for the thread 310 identified in the same record. The instructions whose address are specified in the address field 312 are the next sequential breakpoint instructions following the current instruction at which the program 152 is halted in the thread 310 and/or the target instructions of branch instructions if the current instruction at which the program 152 was halted (when the breakpoint was set) in the thread 310 was a branch instruction.

FIG. 4 depicts a block diagram of an example data structure for a line step breakpoint table 160, according to an embodiment of the invention. The line step breakpoint table 160 comprises example records 402, 404, and 406, each comprising an example thread identifier field 410 and a breakpoint address field 412. The thread identifier field 410 specifies an identifier of a thread 154 in a program 152. The address field 412 specifies an address of breakpoint instruction(s) or lines that are set in the program 152 for the thread 310 identified in the same record. In an embodiment, a line refers to a line or high-level statement in a program not directly executable by a processor while an instruction refers to a low-level machine executable instruction.

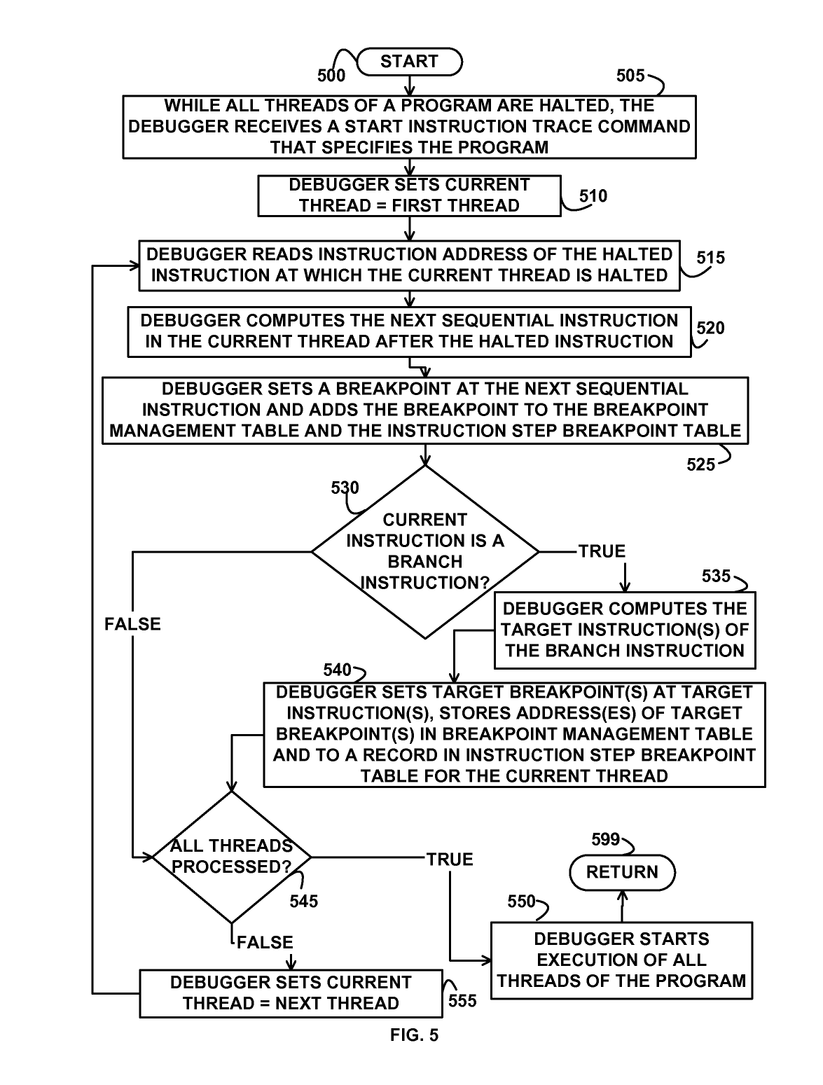

FIG. 5 depicts a flowchart of example processing for a start instruction trace command, according to an embodiment of the invention. Control begins at block 500. Control then continues to block 505 where, while all threads 154 of a program 152 are halted, the debugger 150 receives a start instruction trace command, from a user interface at the user I/O device 121 or from an application program, that specifies the program 152. Control then continues to block 510 where, in response to the start instruction trace command, the debugger 150 sets the current thread to be the first thread of the program 152. Control then continues to block 515 where the debugger 150 reads the instruction address of the halted instruction at which the current thread is halted. All of the threads of the program 152 are not necessarily halted at the same instruction of the program 152, and some or all of the threads may be halted at different instructions of the program 152. Control then continues to block 520 where the debugger 150 computes the next sequential instruction in the current thread after the halted instruction. The next sequential instruction is the next instruction, in instruction address order, from the beginning to the end of the program 152. In an embodiment, the debugger 150 calculates the next sequential instruction by adding the length (or size) of the halted instruction to the instruction pointer or the instruction register. The instruction pointer or register points at or contains the address in the memory 102 of the current instruction that the processor is executing or is about to execute.

Control then continues to block 525 where the debugger 150 sets a breakpoint at the calculated next sequential instruction, replaces the next sequential instruction in the program with an invalid instruction, adds the set breakpoint to a record in the breakpoint management table 156, and stores the set breakpoint and thread indicator of the current thread to a record in the instruction step breakpoint table 158. Control then continues to block 530 where the debugger 150 determines whether the current instruction in the current thread is a branch instruction. A branch (or jump) instruction conditionally or unconditionally alters the flow of execution control of the current thread. Examples of branch instructions include conditional statements and subroutine, procedure, or method calls or invocations. A branch instruction comprises an optional condition and a target address. If the optional condition exists and is satisfied, the processor transfers the flow of execution control of the thread to the instruction that is stored at the target address. If the optional condition does not exist in the branch instruction, then the processor unconditionally transfers the flow of execution control to the target instruction that is stored at the target address. If the optional condition exists in the branch instruction but is not satisfied, then the processor does not transfer the flow of execution control to the target instruction at the target address, but instead the control flow of execution proceeds to the next sequential instruction (the next sequential instruction in memory, in increasing address order) following the branch instruction.

In various embodiments, the condition may comprise the existence of a particular value of a CPU flag or register or the matching of contents of a memory location to a particular value. In various embodiments, the condition may comprise relational operators (e.g., greater than, less than, equal to, not equal to, greater than or equal to, less than or equal to, or any other relational operator); logical operators (e.g., AND, OR, XOR, NOT, NOR, NAND, or any other logical operator); arithmetic operators (e.g., multiplication, division, addition, subtraction, bases, powers, logarithms, or any other arithmetic operators); and register operations (e.g., shift left, shift right operations, or any other register operation); and the relational operators, the logical operators, the arithmetic operators, and the register operations may have any number of arguments or operands (e.g., they may be unary, binary, ternary, or n-ary).

If the determination at block 530 is true, then the current instruction is a branch instruction, so control continues to block 535 where the debugger 150 computes the target instruction(s) of the branch instruction. Control then continues to block 540 where the debugger 150 sets target breakpoint(s) at the target instruction(s) and stores the address(es) of the target breakpoint(s) in the breakpoint management table 156. The debugger 150 further adds address(es) of the target breakpoint(s) and the replaced opcode to a record in the instruction step breakpoint table 158 that specifies the current thread.

Control then continues to block 545 where the debugger 150 determines whether all threads 154 of the program 152 have been processed by the loop that starts at block 515. if the determination at block 545 is true, then all threads 154 of the program 152 have been processed by the logic of the loop that starts at block 515, so control continues to block 550 where the debugger 150 starts execution of all threads 154 of the program 152 on the processor 101. Control then continues to block 599 where the logic of FIG. 5 returns.

If the determination at block 545 is false, then all threads 154 of the program 152 have not been processed by the logic of the loop that starts at block 515, so control continues to block 555 where the debugger 150 sets the current thread to be the next thread of the program 152 that is unprocessed by the logic of the loop that starts at block 515. Control then returns to block 515 where the debugger 150 reads the instruction address of the halted instruction at which the next current thread is halted, as previously described above. If the determination at block 530 is false, then the current instruction is not a branch instruction, so control continues to block 545, as previously described above, without settng target breakpoints.

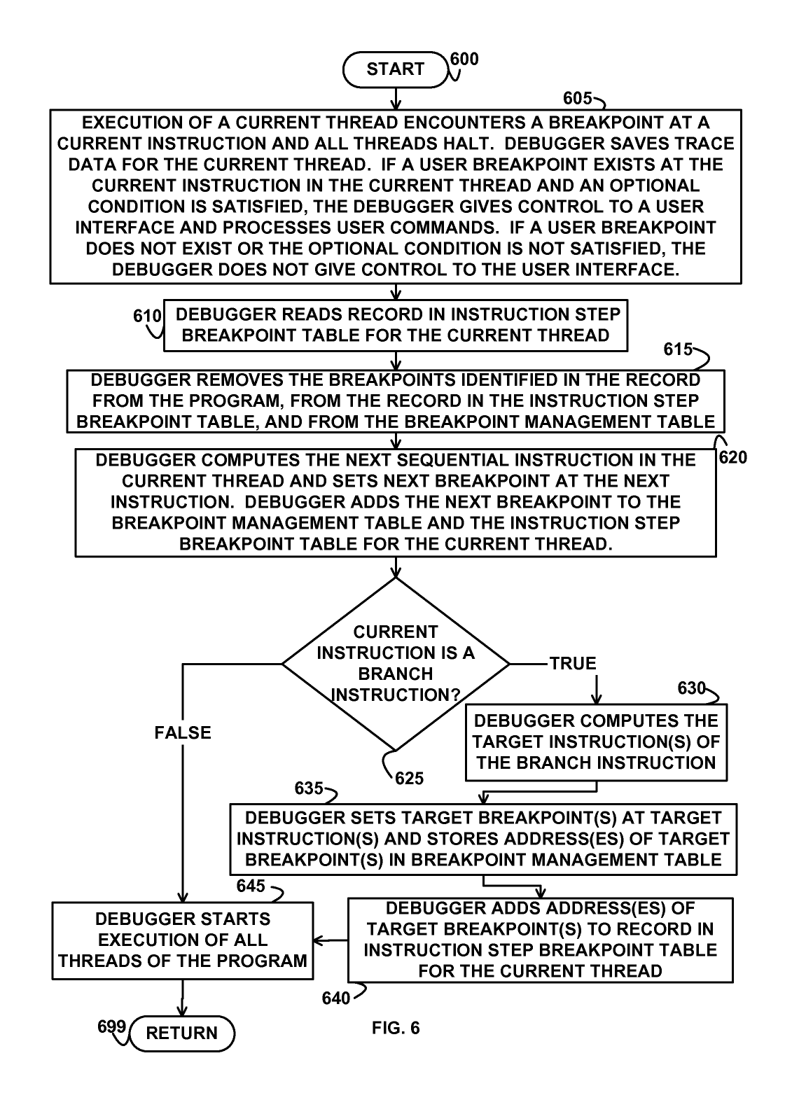

FIG. 6 depicts a flowchart of example processing for execution of a thread encountering a breakpoint while instruction trace is active, according to an embodiment of the invention. The logic of FIG. 6 is executed for each thread as it encounters its respective next sequential breakpoint that was set in FIG. 5, and for each thread as it encounters its respective next sequential breakpoint and possible target breakpoint(s), as further described below with reference to blocks 620 and 635 of FIG. 6.

Control begins at block 600. Control then continues to block 605 where execution of a current thread of a program 152 encounters a breakpoint at a current instruction, and all threads 154 of the program 152 halt. In response, the debugger 150 saves data that describes the execution of the current thread to the trace data 162, but does not save trace data for any other thread. If a user breakpoint (a breakpoint requested by the user via a user interface or application that was not set by the logic of FIG. 5 or 6) exists at the current instruction in the current thread and an optional condition is satisfied, the debugger 150 gives control to a user interface and processes user commands. If a user breakpoint does not exist or the optional condition is not satisfied, the debugger 150 does not give control to the user interface.

Control then continues to block 610 where the debugger 150 reads the record in instruction step breakpoint table 158 that comprises a thread identifier that matches (is identical to) the identifier of the current thread. Control then continues to block 615 where the debugger 150 removes the breakpoint(s) identified in the record from the program 152, removes the breakpoint(s) from the record in the instruction step breakpoint table 158, and removes the breakpoint(s) from the breakpoint management table 156. Control then continues to block 620 where the debugger 150 computes the next sequential instruction (in increasing instruction address order from the current instruction in the current thread) and sets next breakpoint at the next sequential instruction in the program. The debugger 150 adds the next breakpoint to the breakpoint management table 156 and to the instruction step breakpoint table 158 in the records that specify the current thread.

Control then continues to block 625 where the debugger 150 determines whether the current instruction in the current thread is a branch instruction. If the determination at block 625 is true, then the current instruction is a branch instruction, so control continues to block 630 where the debugger 150 computes the target instruction(s) of the branch instruction. Control then continues to block 635 where the debugger 150 sets target breakpoint(s) at the target instruction(s) and stores the address(es) of the target breakpoint(s) in the breakpoint management table 156. Control then continues to block 640 where the debugger 150 adds address(es) of the target breakpoint(s) to a record in the instruction step breakpoint table 158 that specifies the current thread. Control then continues to block 645 where the debugger 150 starts execution of all threads 154 of the program 152 on the processor 101. Control then continues to block 699 where the logic of FIG. 6 returns. Thus, the debugger 150 saves trace data for each thread at different times that execution of the program halted, in response to each thread encountering its own respective next sequential breakpoint and possible target breakpoint(s), which are different breakpoints than set for other threads.

If the determination at block 625 is false, then the current instruction is not a branch instruction, so control continues to block 645 where the debugger 150 starts execution of all threads 154 of the program 152 on the processor 101, without setting target breakpoints. Control then continues to block 699 where the logic of FIG. 6 returns.

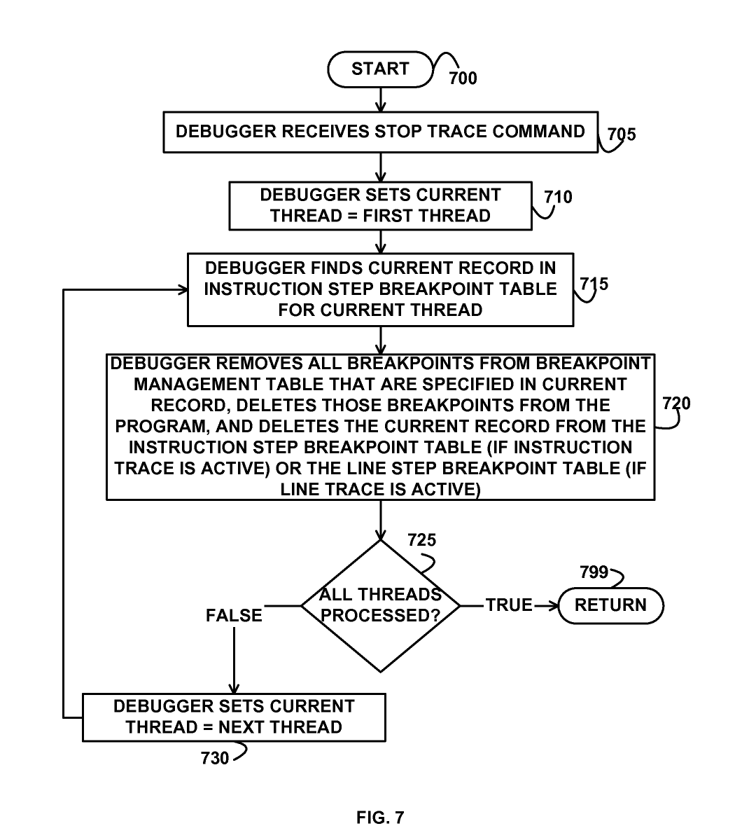

FIG. 7 depicts a flowchart of example processing for a stop trace command, according to an embodiment of the invention. Control begins at block 700. Control then continues to block 705 where the debugger 150 receives a stop trace command from a user interface via the user I/O device 121 or from an application. The stop trace command identifies one of the programs 152 that is executing with trace active (either instruction trace or line trace). Control then continues to block 710 where, in response to receiving the stop trace command, the debugger 150 sets a current thread to be a first thread of the executing program 152.

Control then continues to block 715 where the debugger 150 finds the current record in the instruction step breakpoint table 158 (if instruction trace is active) or the current record in the line step breakpoint table 160 (if line trace is active) that specifies the current thread. Control then continues to block 720 where the debugger 150 removes all breakpoints from the breakpoint management table 156 that are specified in the current record, removes those breakpoints from the program 152, and deletes the current record from the instruction step breakpoint table 158 (if instruction trace is active) or the line step breakpoint table 160 (if line trace is active). Control then continues to block 725 where the debugger 150 determines whether all threads 154 of the program 152 have been processed by the loop that starts at block 715. If the determination at block 725 is true, then all threads 154 of the program 152 have been processed by the logic of the loop that starts at block 715, so control continues to block 799 where the logic of FIG. 7 returns. If the determination at block 725 is false, then all threads 154 of the program 152 have not been processed by the logic of the loop that starts at block 715, so control continues to block 730 where the debugger 150 sets the current thread to be the next thread of the program 152 that is unprocessed by the logic of the loop that starts at block 715. Control then returns to block 715 where the debugger 150 reads the instruction address of the halted instruction at which the next current thread is halted, as previously described above.

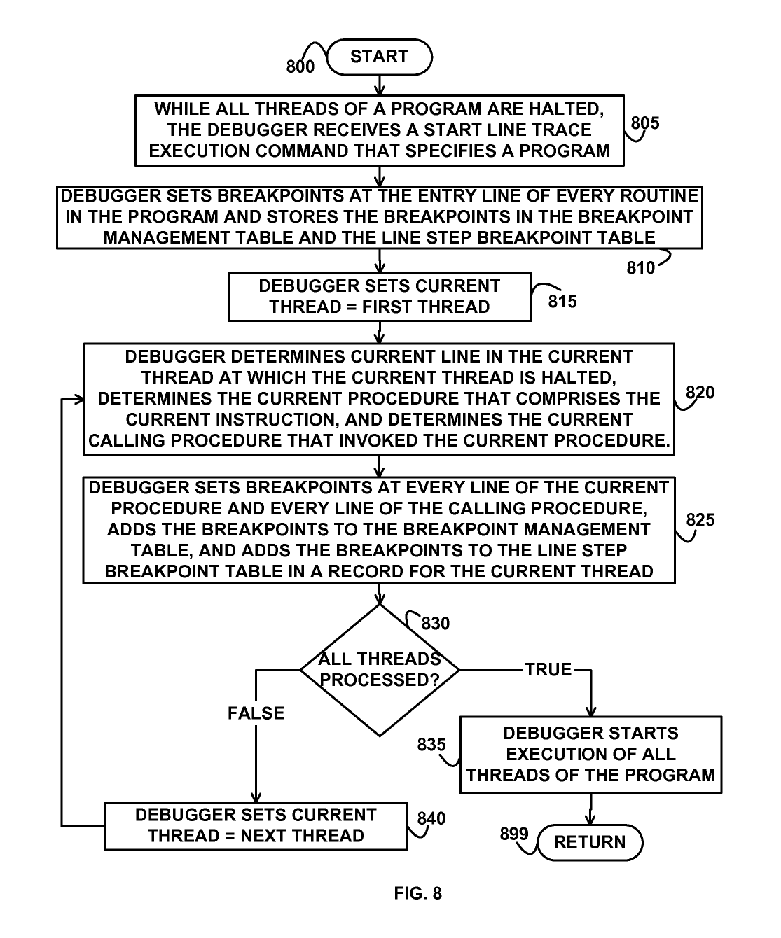

FIG. 8 depicts a flowchart of example processing for a start line trace execution command, according to an embodiment of the invention. Control begins at block 800. Control then continues to block 805 where, while all threads 154 of a program 152 are halted, the debugger 150 receives a start line trace command that specifies the program 152. Control then continues to block 810 where, in response to the start line trace command, the debugger 150 sets the current thread to be the first thread of the program 152. Control then continues to block 815 where the debugger 150 sets breakpoints at the entry or first line of every routine, procedure, method, sub-procedure in the program 152 and stores the breakpoints in the breakpoint management table 156 and the line step breakpoint table 160.

Control then continues to block 815 where the debugger 150 sets current thread to be the first thread in the program 152. Control then continues to block 820 where the debugger 150 determines the current line or statement in the current thread at which the current thread is halted, determines the current procedure in the program 152 that comprises the current instruction, and determines the current calling procedure in the program 152 that called, invoked, or transferred control to the current procedure in the program 152. Procedures are units or subdivisions of lines in the program 152. In an embodiment, the debugger 150 determines the current procedure and the calling procedure via reading entries from a call or invocation stack. Control then continues to block 825 where the debugger 150 sets breakpoints at every line of the current procedure and at every line of the calling procedure, adds the set breakpoints to the breakpoint management table 156, and adds the set breakpoints to the line step breakpoint table 160 in a record that specifies the current thread.

Control then continues to block 830 where the debugger 150 determines whether all threads 154 of the program 152 have been processed by the loop that starts at block 820. If the determination at block 830 is true, then all threads 154 of the program 152 have been processed by the logic of the loop that starts at block 820, so control continues to block 835 where the debugger 150 starts execution of all threads 154 of the program 152 on the processor 101. Control then continues to block 899 where the logic of FIG. 8 returns. If the determination at block 830 is false, then all threads 154 of the program 152 have not been processed by the logic of the loop that starts at block 820, so control continues to block 840 where the debugger 150 sets the current thread to be the next thread of the program 152 that is unprocessed by the logic of the loop that starts at block 820. Control then returns to block 820, as previously described above.

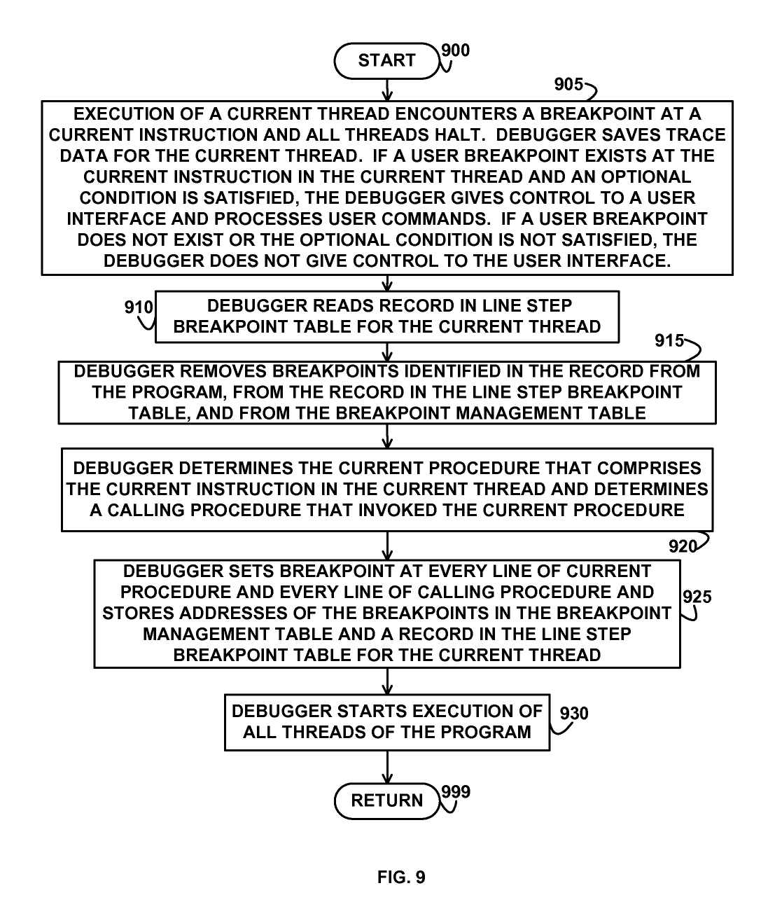

FIG. 9 depicts a flowchart of example processing for execution of a thread encountering a breakpoint while line trace is active, according to an embodiment of the invention. Control begins at block 900. Control then continues to block 905 where execution of a current thread of a program encounters a breakpoint at a current instruction in the current thread and all threads 154 of the program halt execution. In response, the debugger 150 saves trace data 162 for the current thread but not for other threads. If a user breakpoint exists at the current instruction in the current thread and an optional condition is satisfied, the debugger 150 gives control to a user interface at the user I/O device 121 and processes user commands submitted via the user interface. If a user breakpoint does not exist at the current instruction in the current thread or the optional condition is not satisfied, the debugger 150 does not give control to the user interface.

Control then continues to block 910 where the debugger 150 reads the record in the line step breakpoint table 160 that specifies the identifier of the current thread. Control then continues to block 915 where the debugger 150 removes or deletes the breakpoints that are identified in the record from the program 152, from the record in the line step breakpoint table 160, and from the breakpoint management table 156. Control then continues to block 920 where the debugger 150 determines the current procedure that comprises the current instruction in the current thread and determines a calling procedure that invoked or called the current procedure. Control then continues to block 925 where the debugger 150 sets a breakpoint at every line of the current procedure and every line of the calling procedure and stores addresses of the breakpoints into the breakpoint management table 156 and into a record in the line step breakpoint table 160 that specifies an identifier of the current thread. Control then continues to block 930 where the debugger 150 starts execution of all threads 154 of the program 152. Control then continues to block 999 where the logic of FIG. 9 returns.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
determining a plurality of halted addresses of a plurality of halted instructions at which an execution of a plurality of threads of a program are halted;
computing a respective next sequential instruction in the plurality of threads following the plurality of halted instructions;
setting a respective next sequential breakpoint at the respective next sequential instruction in the plurality of threads;
starting the execution of the plurality of threads after the setting the respective next sequential breakpoint; and
in response to the execution of each of the plurality of threads encountering the respective next sequential breakpoint and all of the plurality of threads halting, saving respective trace data that describes the execution of each of the plurality of threads.

2. The method of claim 1, further comprising:
computing a respective target instruction for a subset of the plurality of halted instructions that are branch instructions and setting a respective target breakpoint at the respective target instruction.

3. The method of claim 2, further comprising:
in response to the execution of each of a subset of the plurality of threads encountering the respective target breakpoint at the respective target instruction and all of the plurality of threads halting, saving the respective trace data that describes the execution of the subset of the plurality of threads and starting the execution of all of the plurality of threads.

4. The method of claim 3, wherein the respective target breakpoint is different for each of the plurality of threads and each of the plurality of threads encounters the respective target breakpoint at different times.

5. The method of claim 1, further comprising:
in response to the execution of each of the plurality of threads encountering the respective next sequential breakpoint and all of the plurality of threads halting, removing the respective next sequential breakpoint and starting the execution of all of the plurality of threads.

6. The method of claim 1, further comprising:
for each of the plurality of threads, setting a respective first plurality of breakpoints at every line in a respective current procedure of the program at which the each of the plurality of threads is halted and setting a respective second plurality of breakpoints at every line in a respective calling procedure of the program, wherein the calling procedure called the current procedure.

7. The method of claim 6, further comprising:
in response to the execution of each of the plurality of threads encountering each of the first plurality of breakpoints and each of the second plurality of breakpoints, saving the respective trace data, removing the each of the first plurality of breakpoints and the second plurality of breakpoints, and starting the execution of the program.

8. A computer-readable storage medium encoded with instructions, wherein the instructions when executed comprise:
determining a plurality of halted addresses of a plurality of halted instructions at which an execution of a plurality of threads of a program are halted;
computing a respective next sequential instruction in the plurality of threads following the plurality of halted instructions;
setting a respective next sequential breakpoint at the respective next sequential instruction in the plurality of threads;
starting the execution of the plurality of threads after the setting the respective next sequential breakpoint; and
in response to the execution of each of the plurality of threads encountering the respective next sequential breakpoint and all of the plurality of threads halting, saving respective trace data that describes the execution of each of the plurality of threads.

9. The computer-readable storage medium of claim 8, further comprising:
computing a respective target instruction for a subset of the plurality of halted instructions that are branch instructions and setting a respective target breakpoint at the respective target instruction.

10. The computer-readable storage medium of claim 9, further comprising:
in response to the execution of each of a subset of the plurality of threads encountering the respective target breakpoint at the respective target instruction and all of the plurality of threads halting, saving the respective trace data that describes the execution of the subset of the plurality of threads and starting the execution of all of the plurality of threads.

11. The computer-readable storage medium of claim 10, wherein the respective target breakpoint is different for each of the plurality of threads and each of the plurality of threads encounters the respective target breakpoint at different times.

12. The computer-readable storage medium of claim 8, further comprising:
in response to the execution of each of the plurality of threads encountering the respective next sequential breakpoint and all of the plurality of threads halting, removing the respective next sequential breakpoint and starting the execution of all of the plurality of threads.

13. The computer-readable storage medium of claim 8, further comprising:
for each of the plurality of threads, setting a respective first plurality of breakpoints at every line in a respective current procedure of the program at which the each of the plurality of threads is halted and setting a respective second plurality of breakpoints at every line in a respective calling procedure of the program, wherein the calling procedure called the current procedure.

14. The computer-readable storage medium of claim 13, further comprising:
in response to the execution of each of the plurality of threads encountering each of the first plurality of breakpoints and each of the second plurality of breakpoints, saving the respective trace data, removing the each of the first plurality of breakpoints and the second plurality of breakpoints, and starting the execution of the program.

15. A computer comprising:
a processor; and
memory communicatively coupled to the processor, wherein the memory is encoded with instructions, wherein the instructions when executed on the processor comprise:
determining a plurality of halted addresses of a plurality of halted instructions at which an execution of a plurality of threads of a program are halted,
computing a respective next sequential instruction in the plurality of threads following the plurality of halted instructions,
setting a respective next sequential breakpoint at the respective next sequential instruction in the plurality of threads,
starting the execution of the plurality of threads after the setting the respective next sequential breakpoint,
in response to the execution of each of the plurality of threads encountering the respective next sequential breakpoint and all of the plurality of threads halting, saving respective trace data that describes the execution of each of the plurality of threads, and
computing a respective target instruction for a subset of the plurality of halted instructions that are branch instructions and setting a respective target breakpoint at the respective target instruction.

16. The computer of claim 15, wherein the instructions further comprise:
in response to the execution of each of a subset of the plurality of threads encountering the respective target breakpoint at the respective target instruction and all of the plurality of threads halting, saving the respective trace data that describes the execution of the subset of the plurality of threads and starting the execution of all of the plurality of threads.

17. The computer of claim 16, wherein the respective target breakpoint is different for each of the plurality of threads and each of the plurality of threads encounters the respective target breakpoint at different times.

18. The computer of claim 15, wherein the instructions further comprise:
in response to the execution of each of the plurality of threads encountering the respective next sequential breakpoint and all of the plurality of threads halting, removing the respective next sequential breakpoint and starting the execution of all of the plurality of threads.

19. The computer of claim 15, wherein the instructions further comprise:
for each of the plurality of threads, setting a respective first plurality of breakpoints at every line in a respective current procedure of the program at which the each of the plurality of threads is halted and setting a respective second plurality of breakpoints at every line in a respective calling procedure of the program, wherein the calling procedure called the current procedure.

20. The computer of claim 19, wherein the instructions further comprise:
in response to the execution of each of the plurality of threads encountering each of the first plurality of breakpoints and each of the second plurality of breakpoints, saving the respective trace data, removing the each of the first plurality of breakpoints and the second plurality of breakpoints, and starting the execution of the program.
